(19) United States
(12) Patent Application Publication
(10) Pub. No.: US 2025/0225630 A1
(43) Pub. Date: Jul. 10, 2025

(54) APPARATUS, IMAGE CAPTURING APPARATUS, METHOD, AND STORAGE MEDIUM

(71) Applicant: CANON KABUSHIKI KAISHA, Tokyo (JP)

(72) Inventor: NAOTO KIMURA, Kanagawa (JP)

(21) Appl. No.: 18/999,062

(22) Filed: Dec. 23, 2024

(30) Foreign Application Priority Data
Jan. 5, 2024 (JP) 2024-000801

(51) Int. Cl. G06T 5/80; G06T 5/92

(52) U.S. Cl. CPC G06T 5/80; G06T 5/92; G06T 2207/30168

(57) ABSTRACT

An evaluation image generation unit generates, based on an image, an evaluation image for haze correction. A transmission map generation unit generates, based on the evaluation image, a transmission map for the haze correction. A first correction unit applies the haze correction that is based on the transmission map to the evaluation image. A second correction unit applies the haze correction that is based on the transmission map to the image. A third correction unit corrects, based on an amount of change in the evaluation image before and after the application of the haze correction, brightness of the image to which the haze correction has already been applied.

### BACKGROUND

### Technical Field

One disclosed aspect of the embodiments relates to an apparatus, an image capturing apparatus, a method, and a storage medium.

### Description of the Related Art

There is a known technique called haze correction, which estimates a haze amount of an image as a transmission map based on a known method called a dark channel prior method that uses a haze model, and realizes an effect of removal of haze from the image based on the estimated transmission map. Haze correction is used in improvement of visibility of surveillance camera videos, adjustment of how images shot by a camera look, and so forth.

However, if haze correction is carried out using a known technique, an image becomes dark due to the principle of the technique. Therefore, in a case where haze correction has been carried out with respect to an image that has been shot by a camera under appropriate brightness through exposure control, there is a possibility that the image looks underexposed and gives an unfavorable impression depending on a scene. Furthermore, as the image becomes not only dark but also high in saturation, the colors thereof look unnatural depending on a scene.

Japanese Patent Laid-Open No. 2017-138647 discloses a technique to calculate an enhancement suppression region, which is at least one of a sky region and a contre-jour region that is estimated to be a region including contre-jour, and suppress the intensity of haze correction in the enhancement suppression region. Also, Japanese Patent Laid-Open No. 2019-165832 discloses a technique to convert color signals before and after haze correction into the HSV color space, calculate a saturation value difference based on pixel saturation values before and after the haze correction, and correct the saturation of an image after the haze correction based on the saturation value difference.

However, with the technique of Japanese Patent Laid-Open No. 2017-138647, the effect of haze removal in the enhancement suppression region decreases even in a case where the enhancement suppression region exhibits a small change in brightness. Also, in Japanese Patent Laid-Open No. 2019-165832, the relationship among color components of a target image for saturation correction is not fully considered.

### SUMMARY

One disclosed aspect of the embodiments provides an apparatus comprising: at least one processor; and a memory coupled to the at least one processor storing instructions that, when executed by the processor, cause the processor to function as: an evaluation image generation unit that generates, based on an image, an evaluation image for haze correction; a transmission map generation unit that generates, based on the evaluation image, a transmission map for the haze correction; a first correction unit that applies the haze correction that is based on the transmission map to the evaluation image; a second correction unit that applies the haze correction that is based on the transmission map to the image; and a third correction unit that corrects, based on an amount of change in the evaluation image before and after the application of the haze correction, brightness of the image to which the haze correction has already been applied. One disclosed aspect of the embodiments provides an image capturing apparatus, comprising: the apparatus according to the above disclosed aspect; and an image sensor that generates the image.

One disclosed aspect of the embodiments provides an apparatus comprising: at least one processor; and a memory coupled to the at least one processor storing instructions that, when executed by the processor, cause the processor to function as: a first correction unit that applies haze correction to an image that includes a plurality of color components; and a second correction unit that corrects saturation of the image to which the haze correction has already been applied, by correcting a color difference of the image to which the haze correction has already been applied based on an amount of change in a color difference of the image before and after the application of the haze correction without changing a predetermined color component among the plurality of color components.

One disclosed aspect of the embodiments provides an image capturing apparatus, comprising: the apparatus according to the above disclosed aspect; and an image sensor that generates the image.

One disclosed aspect of the embodiments provides a method executed by an apparatus, comprising: generating, based on an image, an evaluation image for haze correction; generating, based on the evaluation image, a transmission map for the haze correction; applying the haze correction that is based on the transmission map to the evaluation image; applying the haze correction that is based on the transmission map to the image; and correcting, based on an amount of change in the evaluation image before and after the application of the haze correction, brightness of the image to which the haze correction has already been applied.

One disclosed aspect of the embodiments provides a method executed by an apparatus, comprising: applying haze correction to an image that includes a plurality of color components; and correcting saturation of the image to which the haze correction has already been applied, by correcting a color difference of the image to which the haze correction has already been applied based on an amount of change in a color difference of the image before and after the application of the haze correction without changing a predetermined color component among the plurality of color components.

One disclosed aspect of the embodiments provides a non-transitory computer-readable storage medium which stores a program for causing a computer to execute a method comprising: generating, based on an image, an evaluation image for haze correction; generating, based on the evaluation image, a transmission map for the haze correction; applying the haze correction that is based on the transmission map to the evaluation image; applying the haze correction that is based on the transmission map to the image; and correcting, based on an amount of change in the evaluation image before and after the application of the haze correction, brightness of the image to which the haze correction has already been applied.

One disclosed aspect of the embodiments provides a non-transitory computer-readable storage medium which stores a program for causing a computer to execute a method comprising: applying haze correction to an image that includes a plurality of color components; and correcting saturation of the image to which the haze correction has already been applied, by correcting a color difference of the image to which the haze correction has already been applied based on an amount of change in a color difference of the image before and after the application of the haze correction without changing a predetermined color component among the plurality of color components.

According to the disclosure, a technique is provided that improves the image quality of an image to which haze correction has been applied. Further features of the present disclosure will become apparent from the following description of exemplary embodiments with reference to the attached drawings.

### BRIEF DESCRIPTION OF THE DRAWINGS

FIG. 1 is a block diagram showing a configuration of an image capturing apparatus 100 that includes an image processing apparatus.

FIG. 2 is a block diagram showing a configuration of an image processing unit 102 according to a first embodiment.

FIG. 3 is a block diagram showing a configuration of an evaluation image generation unit 202.

FIG. 4 is a block diagram showing a configuration of a correction processing unit 204.

FIG. 5 is a flowchart showing the operations of the image processing unit 102.

FIG. 6 is a flowchart showing the details of processing of step S502.

FIG. 7 is a flowchart showing the details of processing of step S504 according to the first embodiment.

FIG. 8 is a conceptual diagram of layer images.

FIG. 9 is a conceptual diagram of correction processing, which includes haze correction and brightness correction, according to the first embodiment.

FIG. 10 is a block diagram showing a configuration of the image processing unit 102 according to a second embodiment.

FIG. 11 is a block diagram showing a configuration of a correction processing unit 1004.

FIG. 12 is a flowchart showing the details of processing of step S504 according to the second embodiment.

FIG. 13 is a conceptual diagram of correction processing, which includes haze correction and saturation correction, according to the second embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

Configuration of Image Capturing Apparatus 100

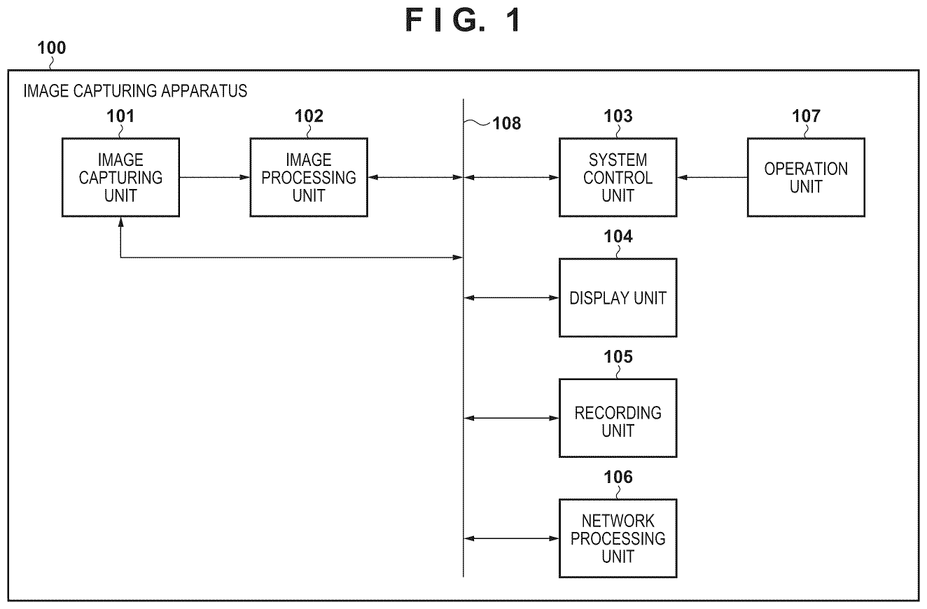

FIG. 1 is a block diagram showing a configuration of an image capturing apparatus 100 that includes an image processing apparatus. In the present embodiment, the image capturing apparatus 100 executes processing for correcting (adjusting) the brightness of an image to prevent the image from becoming too dark when performing haze correction with respect to the image. It is assumed that, as an example, the haze correction of the present embodiment uses a method that estimates haze amounts in an image as transmission maps based on a known method called the dark channel prior method, which uses a haze model, and corrects the image based on the estimated transmission maps.

An image capturing unit 101 includes lenses, an image sensor, an A/D conversion processing unit, and a development processing unit. The image capturing unit 101 generates an image by shooting a subject image based on a control signal output from a system control unit 103 in accordance with a user instruction via an operation unit 107.

An image processing unit 102 executes the haze correction and the brightness correction with respect to an image input from the image capturing unit 101, a recording unit 105, or a network processing unit 106. The details of the image processing unit 102 will be described later.

The system control unit 103 includes a ROM in which a control program is stored, and a RAM used as a working memory, and performs integrated control on the operations of the entire image capturing apparatus 100 in accordance with the control program. Also, the system control unit 103 performs, for example, control for driving the image capturing unit 101 based on a control signal input from the network processing unit 106 and the operation unit 107.

A display unit 104 is a display device that includes a liquid crystal display or an organic electro luminescence (EL) display, and displays images output from the image processing unit 102.

The recording unit 105 has a function of recording data of images and the like. For instance, the recording unit 105 may include an information recording medium that uses, for example, a package housing a memory card equipped with a semiconductor memory or a rotary recording object, such as a magneto-optical disc. This information recording medium may be configured to be attachable to and removable from the image capturing apparatus 100.

The network processing unit 106 executes processing for communicating with an external device. For example, the network processing unit 106 may be configured to obtain images from an external input device via a network. Also, the network processing unit 106 may be configured to transmit images output from the image processing unit 102 to an external display device or image processing apparatus (e.g., a personal computer (PC)) via a network.

The operation unit 107 is configured to include such operation members as buttons and a touch panel, and to accept an input operation performed by a user. The operation unit 107 outputs a control signal corresponding to the user's input operation to the system control unit 103. The user can issue a user instruction to the system control unit 103 via the input operation performed on the operation unit 107.

A bus 108 is used to exchange data of images and the like among the image capturing unit 101, image processing unit 102, system control unit 103, display unit 104, recording unit 105, and network processing unit 106.
Configuration of Image Processing Unit 102

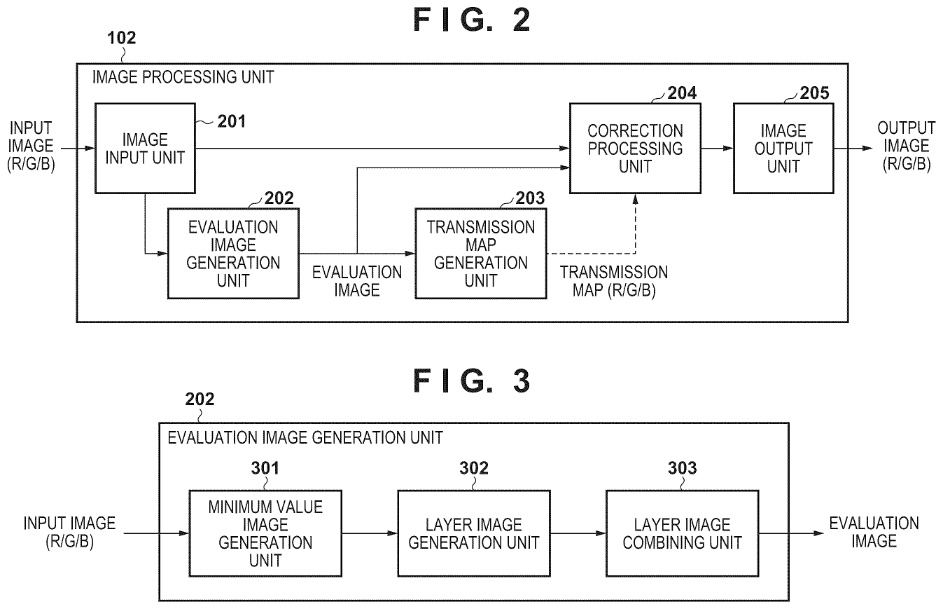

Next, a configuration of the image processing unit 102 will be described with reference to FIG. 2. As shown in FIG. 2, the image processing unit 102 includes an image input unit 201, an evaluation image generation unit 202, a transmission map generation unit 203, a correction processing unit 204, and an image output unit 205. An image that is input to the image processing unit 102 via the image input unit 201 is a target image for haze correction, and is composed of tri-channel signals of red (R), green (G), and blue (B). An image that is output from the image processing unit 102 via the image output unit 205 is an image to which haze correction has been applied. The operations of each unit of the image processing unit 102 will be described later.
Operations of Image Processing Unit 102

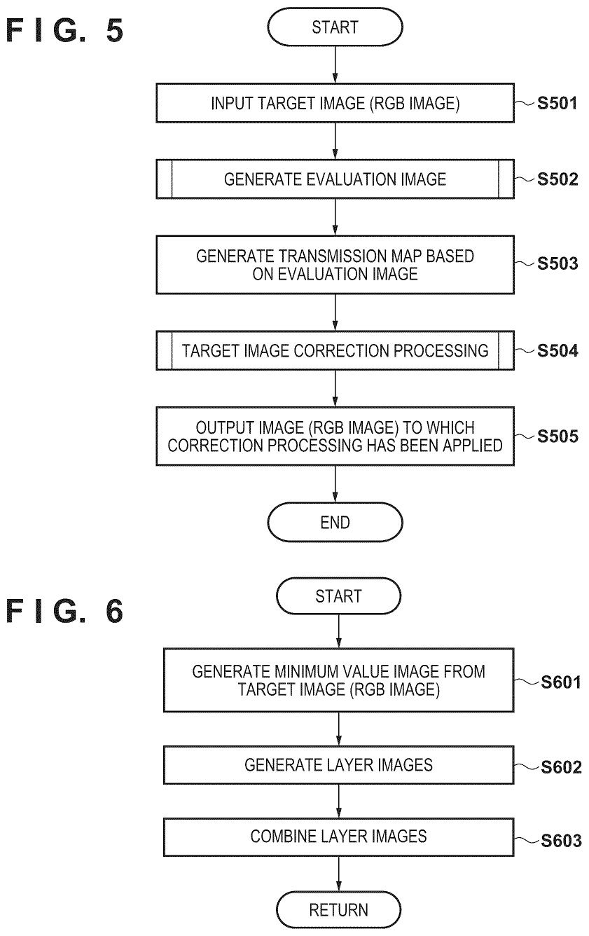

FIG. 5 is a flowchart showing the operations of the image processing unit 102. In step S501, the image input unit 201 accepts an input of a target image (RGB image) for haze correction.

In step S502, the evaluation image generation unit 202 generates an evaluation image for haze correction based on the image input in step S501. The details of processing of step S502 will be described later.

In step S503, the transmission map generation unit 203 generates transmission maps for haze correction based on the evaluation image generated in step S502. The transmission maps are images that include haze amounts in the respective pixels of the target image for haze correction as pixel values. The details of processing of step S503 will be described later.

In step S504, based on the transmission maps generated in step S503, the correction processing unit 204 executes correction processing, which includes haze correction and brightness correction, with respect to the image input in step S501.

In step S505, the image output unit 205 outputs the image (RGB image) to which the correction processing, which includes haze correction and the brightness correction, has been applied in step S504.
Details of Processing of Step S502

Next, the details of processing of step S502 (processing for generating an evaluation image) executed by the evaluation image generation unit 202 will be described with reference to FIG. 3 and FIG. 6.

FIG. 3 is a block diagram showing a configuration of the evaluation image generation unit 202. The evaluation image generation unit 202 includes a minimum value image generation unit 301, a layer image generation unit 302, and a layer image combining unit 303. An image input to the minimum value image generation unit 301 is an RGB image input to the image input unit 201. An image output from the layer image combining unit 303 is an evaluation image that is necessary to generate transmission maps for haze correction.

FIG. 6 is a flowchart showing the details of processing of step S502. In step S601, the minimum value image generation unit 301 generates a minimum value image from the input RGB image in accordance with the following formula (1). In formula (1), (x, y) indicates pixel coordinates (pixel position), pix (x, y) indicates a minimum value image, and R (x, y), G (x, y), and B (x, y) respectively indicate an R signal value, a G signal value, and a B signal value in the RGB image. As can be understood from formula (1), the minimum value image is an image that has minimum values of RGB signals at the respective pixel positions in the RGB image as pixel values.

$$[ Math . 1 ]$$

$$p i x ( x , y ) = min ( R ( x , y ) , G ( x , y ) , B ( x , y ) ) \qquad ( 1 )$$

In step S602, the layer image generation unit 302 executes processing for generating layer images. The layer images refer to a plurality of images with different frequencies. FIG. 8 is a conceptual diagram of the layer images. In FIG. 8, a horizontal axis indicates pixel positions, and a vertical axis indicates signal values (pixel values). In the example of FIG. 8, the layer images include three types of images: a minimum value image 801, a first low-frequency image 802, and a second low-frequency image 803. The minimum value image 801 is the image generated by the minimum value image generation unit 301 in step S601. The first low-frequency image 802 is an image obtained by applying a first low-pass filter to the minimum value image 801. The second low-frequency image 803 is an image obtained by applying a second low-pass filter, which is different in characteristics from the first low-pass filter, to the minimum value image 801. Note that images different from the example of FIG. 8 may be used as the layer images. For example, a plurality of images with different resolutions, which are generated through reduction processing or the like, may be used as the layer images.

In step S603, the layer image combining unit 303 executes processing for generating one evaluation image by combining the layer images generated in step S602. Specifically, the layer image combining unit 303 generates the evaluation image by obtaining the minimum values in each layer in accordance with the following formula (2) based on a known method called the dark channel prior method. In formula (2), pix (x, y) indicates a pixel value in the minimum value image 801. Also, 1pf1 (x, y) indicates a pixel value in the first low-frequency image 802, 1pf2 (x, y) indicates a pixel value in the second low-frequency image 803, and eva (x, y) indicates a pixel value in the evaluation image. As can be understood from formula (2), in the present embodiment, a local minimum value image that has, at each pixel position, the smallest value of the minimum value image and the two low-frequency images as a pixel value is generated as the evaluation image.

$$[ Math . 2 ]$$

$$e v a ( x , y ) = min ( pix ( x , y ) , lpf 1 ( x , y ) , lpf 2 ( x , y ) ) \qquad ( 2 )$$

Details of Processing of Step S503

Next, the details of processing of step S503 will be described. Based on the evaluation image, the transmission map generation unit 203 generates transmission maps for the respective RGB signals. The transmission maps are generated in accordance with the following formula (3).

$$[ Math . 3 ]$$

$${t}_{R} ( x , y ) = \frac{1}{\{ ( \frac{{A}_{R}}{{A}_{R} - e v a ( x , y )} ) - 1 \} \times K + 1} \qquad ( 3 )$$

$${t}_{G} ( x , y ) = \frac{1}{\{ ( \frac{{A}_{G}}{{A}_{G} - e v a ( x , y )} ) - 1 \} \times K + 1}$$

$${t}_{B} ( x , y ) = \frac{1}{\{ ( \frac{{A}_{B}}{{A}_{B} - e v a ( x , y )} ) - 1 \} \times K + 1}$$

In formula (3), t_{R} (x, y), t_{G} (x, y), and t_{B} (x, y) respectively indicate a transmission map for the R signal, a transmission map for the G signal, and a transmission map for the B signal. eva (x, y) indicates the evaluation image that has been obtained in accordance with the aforementioned formula (2). A_{R}, A_{G}, and A_{B} are signal values which indicate an atmospheric image in a haze model and which correspond to R, G, and B, respectively; any values can be used thereas, such as signal values of the sky that respectively correspond to R, G, and B, signal values of a light source like the sun, a light, or the like that respectively correspond to R, G, and B, and the maximum value that an image signal can take (e.g., 4095 in the case of 12-bit image signals). K is an arbitrary parameter, and the intensity of the transmission maps for haze correction can be adjusted by adjusting the value of K.
Details of Processing of Step S504

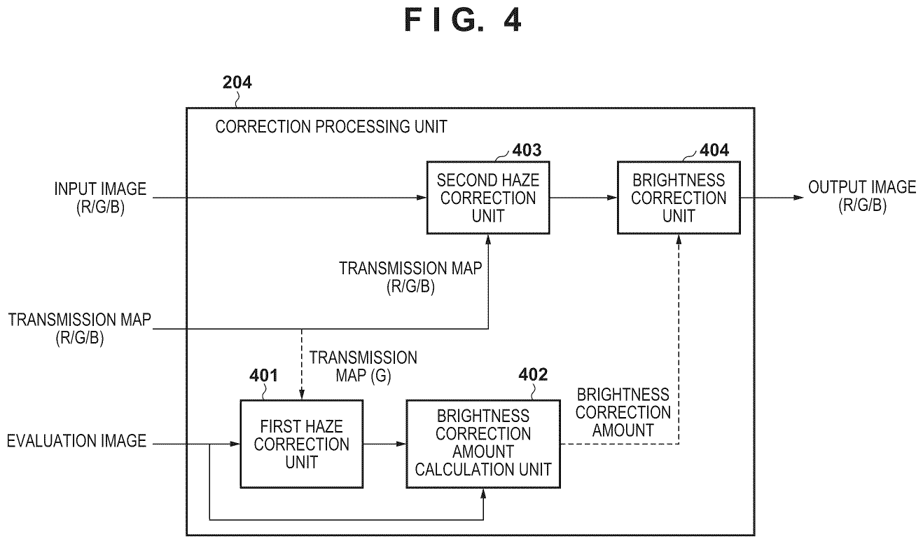

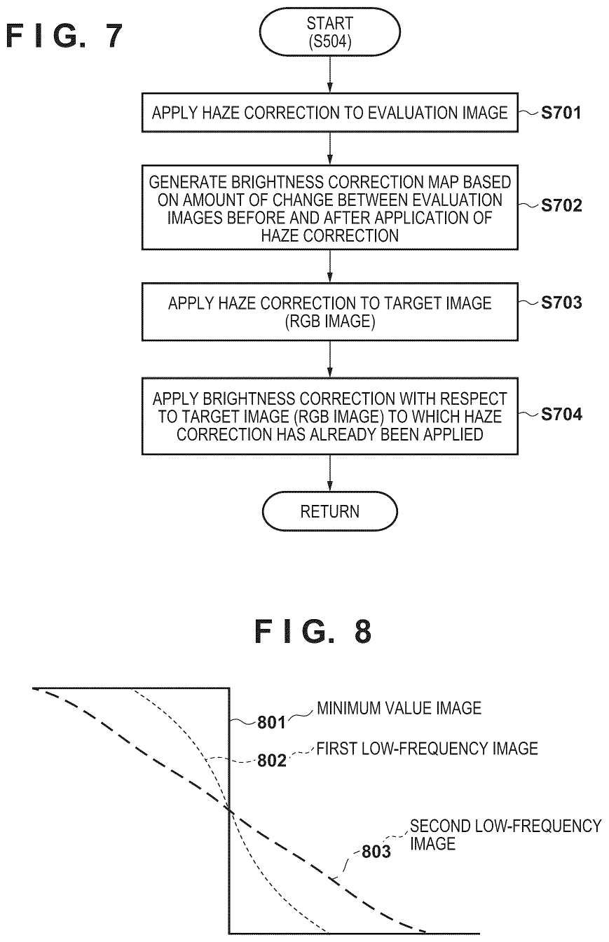

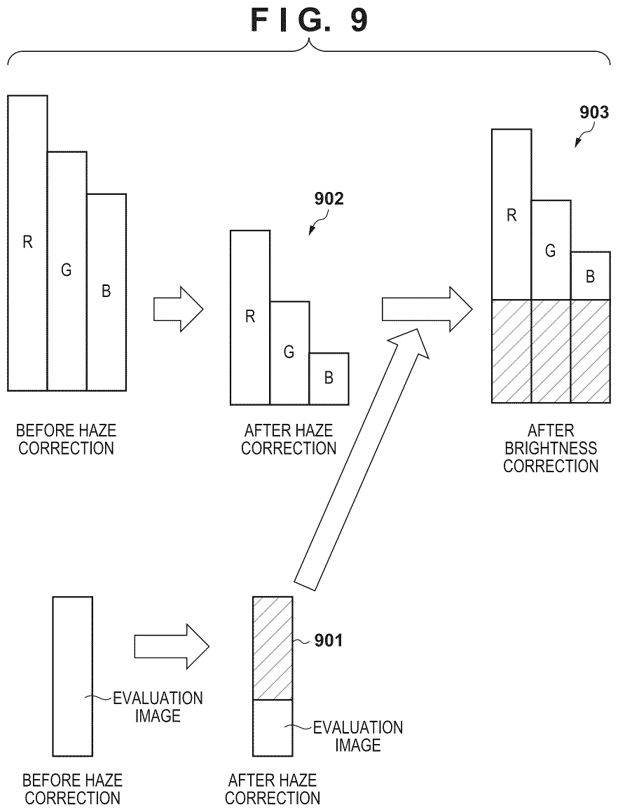

Next, the details of processing of step S504 executed by the correction processing unit 204 will be described with reference to FIG. 4, FIG. 7, and FIG. 9.

FIG. 4 is a block diagram showing a configuration of the correction processing unit 204. The correction processing unit 204 includes a first haze correction unit 401, a brightness correction amount calculation unit 402, a second haze correction unit 403, and a brightness correction unit 404. The RGB image input to the image input unit 201, the evaluation image generated by the evaluation image generation unit 202, and the transmission maps for the respective RGB signals, which have been generated by the transmission map generation unit 203, are input to the correction processing unit 204. The correction processing unit 204 outputs the RGB image to which haze correction and brightness correction have been applied.

FIG. 7 is a flowchart showing the details of processing of step S504 according to the first embodiment. In step S701, the first haze correction unit 401 applies haze correction to the evaluation image by executing gain processing that is based on a transmission map with respect to the evaluation image. The following formula (4) based on the haze model is used in the gain processing for haze correction.

$$[ Math . 4 ]$$

$$out\_eva ( x , y ) = \frac{1}{t ( x , y )} \times ( eva ( x , y ) - A ) + A \qquad ( 4 )$$

In formula (4), eva (x, y) indicates the evaluation image input from the evaluation image generation unit 202, and out_eva (x, y) indicates the evaluation image to which haze correction has already been applied. t (x, y) indicates a transmission map, and A is a signal value indicating an atmospheric image. Note that according to formula (3), the transmission maps for the respective RGB signals are generated, and a signal value indicating an atmospheric image is decided on for each of R, G, and B. On the other hand, the evaluation image corrected by formula (4) is an image including a single-channel signal that has been generated in accordance with formula (2). In view of this, the first haze correction unit 401 uses, for example, values for the G signal (t_{G} (x, y) and A_{G}) as t (x, y) and A in formula (4). Alternatively, the first haze correction unit 401 may use values for the R signal or the B signal as t (x, y) and A in formula (4), or may use values obtained by applying weighted averaging to values for the R signal, values for the G signal, and values for the B signal thereas.

In step S702, the brightness correction amount calculation unit 402 calculates (generates) brightness correction amounts (a brightness correction map) based on the evaluation image to which haze correction has not been applied yet and the evaluation image to which haze correction has already been applied in step S701. Specifically, the brightness correction amount calculation unit 402 generates the brightness correction map based on the amount of change between the evaluation images before and after the application of haze correction as indicated by the following formula (5). In formula (5), adj_map (x, y) indicates the brightness correction map, eva (x, y) indicates the evaluation image to which haze correction has not been applied yet, and out_eva (x, y) indicates the evaluation image to which haze correction has already been applied. k is a parameter for adjusting the intensity of brightness correction, and takes a value that is larger than 0 and equal to or smaller than 1 (the larger the value of k, the higher the intensity).

$$[ Math . 5 ]$$

$$adj\_map ( x , y ) = k \times ( eva ( x , y ) - out\_eva ( x , y ) ) \qquad ( 5 )$$

Note that in formula (5), the difference (the pixel-by-pixel difference between the evaluation image to which haze correction has not been applied yet and the evaluation image to which haze correction has already been applied) is used as the amount of change between the evaluation images before and after the application of haze correction. However, as indicated by the following formula (6), the brightness correction amount calculation unit 402 may use the ratio (the pixel-by-pixel ratio between the evaluation image to which haze correction has not been applied yet and the evaluation image to which haze correction has already been applied) as the amount of change between the evaluation images before and after the application of haze correction.

$$[ Math . 6 ]$$

$$adj\_map ( x , y ) = k \times \{ ( \frac{eva ( x , y )}{out\_eva ( x , y )} ) - 1.0 \} + 1.0 \qquad ( 6 )$$

In step S703, the second haze correction unit 403 applies haze correction to the RGB image by executing gain processing that is based on the transmission maps with respect to the RGB image input from the image input unit 201 (the target image for haze correction).

The following formula (7) based on the haze model is used in the gain processing for haze correction. In formula (7), R (x, y), G (x, y), and B (x, y) indicate RGB signals in the target image, and Ra (x, y), Ga (x, y), and Ba (x, y) indicate RGB signals in the target image to which haze correction has already been applied. t_{R}(x, y), t_{G} (x, y), and t_{B}(x, y) indicate the transmission maps for the respective RGB signals generated in step S503, and A_{R}, A_{G}, and A_{B} indicate signal values of R, G, and B, respectively, which indicate an atmospheric image in the haze model.

$$[ Math . 7 ]$$

$$Ra ( x , y ) = \frac{1}{{t}_{R} ( x , y )} \times ( R ( x , y ) - {A}_{R} ) + {A}_{R} \qquad ( 7 )$$

$$Ga ( x , y ) = \frac{1}{{t}_{G} ( x , y )} \times ( G ( x , y ) - {A}_{G} ) + {A}_{G}$$

$$Ba ( x , y ) = \frac{1}{{t}_{B} ( x , y )} \times ( B ( x , y ) - {A}_{B} ) + {A}_{B}$$

In step S704, the brightness correction unit 404 performs brightness correction that is based on the brightness correction map generated in step S702 with respect to the RGB image to which haze correction has already been applied in step S703.

In a case where the brightness correction map has been generated in accordance with formula (5) (in a case where the difference is used as the amount of change between the evaluation images before and after the application of haze correction), the brightness correction map includes correction values for the respective pixels. In this case, as indicated by the following formula (8), brightness correction is performed by adding the correction values for the respective pixels to the pixels in the target image to which haze correction has already been applied. In formula (8), Ra (x, y), Ga (x, y), and Ba (x, y) indicate RGB signals in the target image to which haze correction has already been applied in accordance with formula (7). adj_map (x, y) indicates the brightness correction map that has been generated in accordance with formula (5). Ro (x, y), Go (x, y), and Bo (x, y) indicate RGB signals in the target image to which brightness correction has already been applied in addition to haze correction.

$$[ Math . 8 ]$$

$$Ro ( x , y ) = R a ( x , y ) + adj\_map ( x , y ) \qquad ( 8 )$$

$$Go ( x , y ) = Ga ( x , y ) + adj\_map ( x , y )$$

$$Bo ( x , y ) = B a ( x , y ) + adj\_map ( x , y )$$

In a case where the brightness correction map has been generated in accordance with formula (6) (in a case where the ratio is used as the amount of change between the evaluation images before and after the application of haze correction), the brightness correction map includes gain values for the respective pixels. In this case, as indicated by the following formula (9), brightness correction is performed by multiplying the pixels in the target image to which haze correction has already been applied by the gain values for the respective pixels. In formula (9), adj_map (x, y) indicates the brightness correction map that has been generated in accordance with formula (6), unlike formula (8).

$$[ Math . 9 ]$$

$$Ro ( x , y ) = Ra ( x , y ) \times adj\_map ( x , y ) \qquad ( 9 )$$

$$Go ( x , y ) = Ga ( x , y ) \times adj\_map ( x , y )$$

$$Bo ( x , y ) = B a ( x , y ) \times adj\_map ( x , y )$$

FIG. 9 is a conceptual diagram of correction processing, which includes haze correction and brightness correction, according to the first embodiment. As shown in FIG. 9, the brightness correction map, which is generated based on the amount of change 901 between the evaluation images before and after the application of haze correction, is applied to an RGB image 902 to which haze correction has already been applied; as a result, an RGB image 903 to which correction processing including haze correction and brightness correction has already been applied is generated.

### Summary of First Embodiment

As described above, according to the first embodiment, the image processing unit 102 generates an evaluation image for haze correction based on an input target image, and generates a transmission map for haze correction based on the evaluation image. Then, the image processing unit 102 applies haze correction that is based on the transmission map to the evaluation image. Also, the image processing unit 102 applies haze correction that is based on the transmission map to the target image, and corrects the brightness of the target image to which haze correction has already been applied based on the amount of change between the evaluation images before and after the application of haze correction.

In this way, according to the present embodiment, the brightness of the target image to which haze correction has already been applied is corrected based on the amount of change between the evaluation images before and after the application of haze correction; this can suppress the possibility that the image to which haze correction has already been applied becomes too dark. Therefore, the present embodiment can improve the image quality of the image to which haze correction has been applied.

### Second Embodiment

The first embodiment has been described in relation to a configuration in which the image quality of an image is improved by correcting the brightness of an image to which haze correction has already been applied. In contrast, a second embodiment will be described in relation to a configuration in which the image quality of an image is improved by correcting the saturation of an image to which haze correction has already been applied. Note that in the second embodiment, the basic configuration of the image capturing apparatus 100 is similar to that of the first embodiment. The following mainly describes the differences from the first embodiment.

In the present embodiment, an image sensor of the image capturing unit 101 is configured to generate an image that includes a plurality of color components. In the following description, it is assumed that, as one example, the image sensor of the image capturing unit 101 generates an image (RGB image) that includes a red component (R component), a green component (G component), and a blue component (B components).

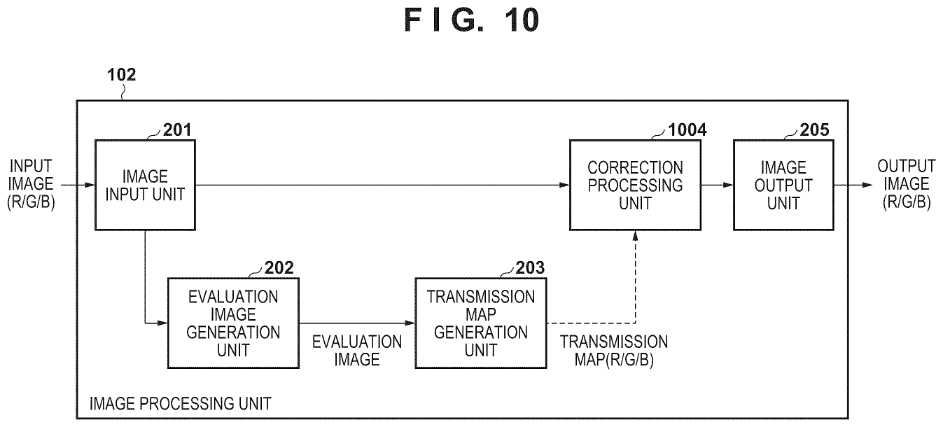

FIG. 10 is a block diagram showing a configuration of the image processing unit 102 according to the second embodiment. As shown in FIG. 10, the image processing unit 102 includes an image input unit 201, an evaluation image generation unit 202, a transmission map generation unit 203, a correction processing unit 1004, and an image output unit 205. An image that is input to the image processing unit 102 via the image input unit 201 is a target image for haze correction, and is composed of tri-channel signals of red (R), green (G), and blue (B). An image that is output from the image processing unit 102 via the image output unit 205 is an image to which haze correction has been applied. As can be understood from FIG. 10, the image processing unit 102 according to the second embodiment differs from the image processing unit 102 according to the first embodiment in that the correction processing unit 204 is replaced with the correction processing unit 1004, and that an evaluation image generated by the evaluation image generation unit 202 is not input to the correction processing unit 1004.

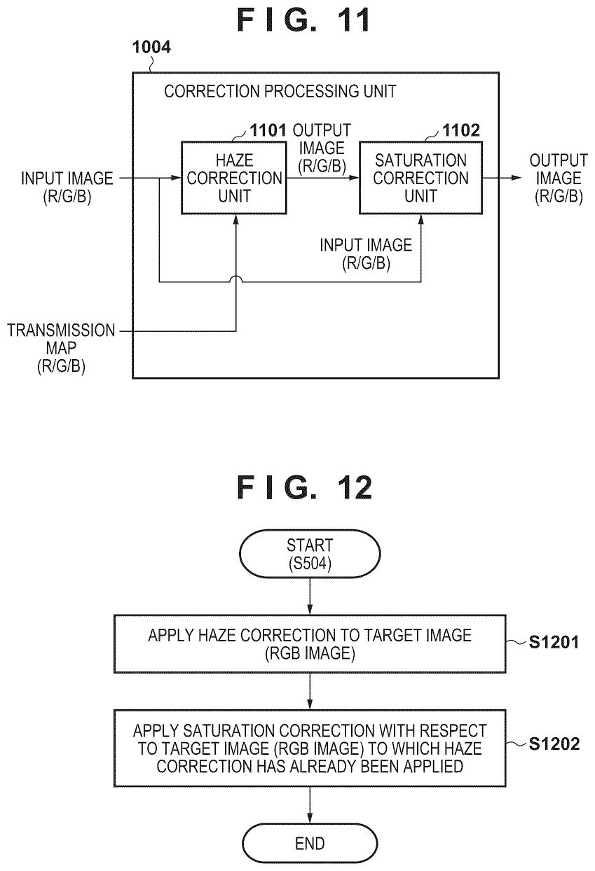

Although the image processing unit 102 performs operations in accordance with the flowchart of FIG. 5 similarly to the first embodiment, the contents of correction processing in step S504 differ from that of the first embodiment. The following describes the details of processing of step S504 executed by the correction processing unit 1004 with reference to FIG. 11 to FIG. 13.

FIG. 11 is a block diagram showing the configuration of the correction processing unit 1004. The correction processing unit 1004 includes a haze correction unit 1101 and a saturation correction unit 1102. The RGB image input to the image input unit 201 and the transmission maps, which have been generated by the transmission map generation unit 203 for R, G, and B, respectively, are input to the correction processing unit 1004. The correction processing unit 1004 outputs the RGB image to which haze correction and saturation correction have been applied.

FIG. 12 is a flowchart showing the details of processing of step S504 according to the second embodiment. In step S1201, the haze correction unit 1101 applies haze correction to the RGB image by executing gain processing that is based on the transmission maps with respect to the RGB image input from the image input unit 201, similarly to step S703 of FIG. 7.

In step S1202, the saturation correction unit 1102 corrects the saturation of the RGB image to which haze correction has already been applied based on the RGB image to which haze correction has not been applied yet and the RGB image to which haze correction has already been applied in step S1201. In the present embodiment, the saturation correction unit 1102 corrects saturation based on the amounts of change in the color differences in the RGB images before and after the application of haze correction.

Specifically, first, the saturation correction unit 1102 calculates the color differences after saturation correction in accordance with the following formula (10). In formula (10), R (x, y), G (x, y), and B (x, y) indicate RGB signals in the target image to which haze correction has not been applied yet, and Ra (x, y), Ga (x, y), and Ba (x, y) indicate RGB signals in the target image to which haze correction has already been applied. RG_adj (x, y) and BG_adj (x, y) indicate color difference signals after saturation correction. k is a parameter for adjusting the intensity of saturation correction, and takes a value that is larger than 0 and equal to or smaller than 1 (the larger the value of k, the higher the intensity).

$$[ Math . 10 ]$$

$$RG\_adj ( x , y ) = k \times \{ ( R a ( x , y ) - Ga ( x , y ) ) - ( R ( x , y ) - G ( x , y ) ) \} + ( R ( x , y ) - G ( x , y ) ) \qquad ( 10 )$$

$$BG\_adj ( x , y ) = k \times \{ ( B a ( x , y ) - Ga ( x , y ) ) - ( B ( x . y ) - G ( x , y ) ) \} + ( B ( x , y ) - G ( x , y ) )$$

In formula (10), (Ra (x, y)-Ga (x, y))-(R (x, y)-G (x, y)) and (Ba (x, y)-Ga (x, y))-(B (x, y)-G (x, y)) represent the amounts of change in the color differences in the RGB images (target images) before and after the application of haze correction. Therefore, the color difference signals RG_adj (x, y) and BG_adj (x, y) after saturation correction are based on the amounts of change in the color differences in the target images before and after the application of haze correction.

Note that in formula (10), the difference (the pixel-by-pixel difference between the color differences in the target image to which haze correction has not been applied yet and the color differences in the target image to which haze correction has already been applied) is used as the amounts of change in the color differences in the target images before and after the application of haze correction. However, as indicated by the following formula (11), the saturation correction unit 1102 may use the ratio (the pixel-by-pixel ratio between the color differences in the target image to which haze correction has not been applied yet and the color difference in the target image to which haze correction has already been applied) as the amounts of change in the color differences in the target images before and after the application of haze correction.

$$[ Math . 11 ]$$

$$RG\_adj \text{} ( x , y ) = [ \text{} k \times \{ \frac{( R a ( x , y ) - Ga ( x , y ) )}{( R ( x , y ) - G ( x , y ) )} - 1.0 \} + 1 \text{.0} ] \times ( R ( x , y ) - G ( x , y ) ) \qquad ( 11 )$$

$$BG\_adj \text{} ( x , y ) = [ \text{} k \times \{ \frac{( B a ( x , y ) - G a ( x , y ) )}{( B ( x , y ) - G ( x , y ) )} - 1.0 \} + 1 \text{.0} ] \times ( B ( x , y ) - G ( x , y ) )$$

Next, in accordance with the following formula (12), the saturation correction unit 1102 performs saturation correction using the color differences after saturation correction, which have been calculated using formula (10) or formula (11). In formula (12), Ro (x, y), Go (x, y), and Bo (x, y) indicate RGB signals in the target image to which saturation correction has already been applied in addition to haze correction.

$$[ Math . 12 ]$$

$$R o ( x , y ) = RG\_adj ( x , y ) + Ga ( x , y ) \qquad ( 12 )$$

$$Bo ( x , y ) = BG\_adj ( x , y ) + G a ( x , y )$$

$$Go ( x , y ) = G a ( x , y )$$

As described above, the color difference signals RG_adj (x, y) and BG_adj (x, y) after saturation correction are based on the amounts of change in the color differences in the target images before and after the application of haze correction. Therefore, saturation correction according to formula (12) is processing for correcting the saturation of the RGB image to which haze correction has already been applied based on the amounts of change in the color differences in the target images (RGB images) before and after the application of haze correction.

According to formula (12), the color differences can be corrected from (Ra (x, y)-Ga (x, y)) and (Ba (x, y)-Ga (x, y)) to RG_adj (x, y) and BG_adj (x, y) without changing the G signal in the RGB signals (Ra (x, y), Ga (x, y), and Ba (x, y)) to which haze correction has already been applied. The G signal in the RGB signals is a signal in a medium-wavelength band that makes the largest contribution to luminance signals indicating brightness. Therefore, by correcting the color differences while using the G signal as a fixed base color signal, the saturation of the RGB image to which haze correction has already been applied can be corrected without making a significant change to the impression of brightness. Furthermore, in a case where saturation correction is performed without changing the base color signal, even if the intensity of saturation correction has changed, it is not necessary to make significant changes to parameters of general signal processing, such as color matrix correction conforming with the RGB spectral characteristics of the image sensor of the image capturing unit 101, and color correction and gamma correction conforming with the saturation level of the image sensor.

Note that although it is assumed in the above description that the base color signal (a predetermined color signal) is the G signal, the R signal or the B signal may be used as the base color signal. In this case, formula (10) to formula (12) are changed as appropriate to calculate the color differences from the base color signal (the R signal or the B signal). Also in a case where the base color signal is the R signal or the B signal, it is possible to achieve the effect whereby the saturation of the target image can be corrected without providing a sense of discomfort to a user.

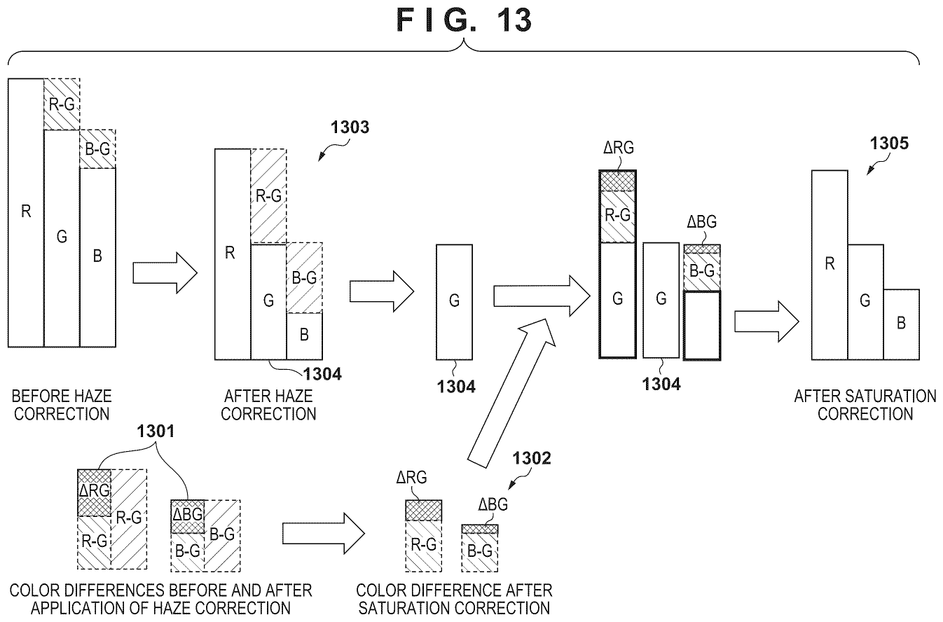

FIG. 13 is a conceptual diagram of correction processing, which includes haze correction and saturation correction, according to the second embodiment. As shown in FIG. 13, color differences 1302 after saturation correction are generated based on the amounts of change 1301 in the color differences in RGB images before and after the application of haze correction. Then, the color differences 1302 after saturation correction are applied to a G signal 1304, which is a base color signal in an RGB image 1303 to which haze correction has already been applied; as a result, an RGB image 1305 is generated to which correction processing, which includes haze correction and saturation correction, has already been applied.

### Summary of Second Embodiment

As described above, according to the second embodiment, the image processing unit 102 applies haze correction to a target image that includes a plurality of color components (a red component, a green component, and a blue component according to the above-described example). Then, the image processing unit 102 corrects the saturation of the target image to which haze correction has already been applied by correcting the color differences in the target image to which haze correction has already been applied based on the amounts of change in the color differences in the target images before and after the application of haze correction without changing a predetermined color component (a green component according to the above-described example) among the plurality of color components.

As described above, according to the present embodiment, the color differences in the target image to which haze correction has already been applied are corrected without changing the predetermined color component among the plurality of color components; thus, the saturation of the target image can be corrected without providing a sense of discomfort to a user. Therefore, the present embodiment can improve the image quality of the image to which haze correction has been applied.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-000801, filed Jan. 5, 2024, which is hereby incorporated by reference herein in its entirety.

What is claimed is:

1. An apparatus comprising:
at least one processor; and
a memory coupled to the at least one processor storing instructions that, when executed by the processor, cause the processor to function as:
an evaluation image generation unit that generates, based on an image, an evaluation image for haze correction;
a transmission map generation unit that generates, based on the evaluation image, a transmission map for the haze correction;
a first correction unit that applies the haze correction that is based on the transmission map to the evaluation image;
a second correction unit that applies the haze correction that is based on the transmission map to the image; and
a third correction unit that corrects, based on an amount of change in the evaluation image before and after the application of the haze correction, brightness of the image to which the haze correction has already been applied.

2. The apparatus according to claim 1,
wherein the third correction unit adds, to respective pixels in the image to which the haze correction has already been applied, pixel-by-pixel correction values that are based on pixel-by-pixel differences between the evaluation image to which the haze correction has not been applied yet and the evaluation image to which the haze correction has already been applied.

3. The apparatus according to claim 1,
wherein the third correction unit multiplies respective pixels in the image to which the haze correction has already been applied by pixel-by-pixel gain values that are based on pixel-by-pixel ratios between the evaluation image to which the haze correction has not been applied yet and the evaluation image to which the haze correction has already been applied.

4. The apparatus according to claim 1,
wherein the evaluation image generation unit generates the evaluation image based on the image and a low-frequency image that is generated from the image.

5. An image capturing apparatus, comprising:
the apparatus according to claim 1; and
an image sensor that generates the image.

6. An apparatus comprising:
at least one processor; and
a memory coupled to the at least one processor storing instructions that, when executed by the processor, cause the processor to function as:
a first correction unit that applies haze correction to an image that includes a plurality of color components; and
a second correction unit that corrects saturation of the image to which the haze correction has already been applied, by correcting a color difference of the image to which the haze correction has already been applied based on an amount of change in a color difference of the image before and after the application of the haze correction without changing a predetermined color component among the plurality of color components.

7. The apparatus according to claim 6,
wherein the plurality of color components include a red component, a green component, and a blue component.

8. The apparatus according to claim 7,
wherein the predetermined color component is the green component.

9. The apparatus according to claim 6,
wherein the second correction unit corrects, on a pixel-by-pixel basis, the color difference of the image to which the haze correction has already been applied, based on pixel-by-pixel differences between the color difference of the image to which the haze correction has not been applied yet and the color difference of the image to which the haze correction has already been applied.

10. The apparatus according to claim 6,
wherein the second correction unit corrects, on a pixel-by-pixel basis, the color difference of the image to which the haze correction has already been applied, based on pixel-by-pixel ratios between the color difference of the image to which the haze correction has not been applied yet and the color difference of the image to which the haze correction has already been applied.

11. The apparatus according to claim 6,
wherein the first correction unit
generates, based on the image, an evaluation image for the haze correction,
generates, based on the evaluation image, a transmission map for the haze correction, and
applies the haze correction to the image based on the transmission map.

12. An image capturing apparatus, comprising:
the apparatus according to claim 6; and
an image sensor that generates the image.

13. A method executed by an apparatus, comprising:
generating, based on an image, an evaluation image for haze correction;
generating, based on the evaluation image, a transmission map for the haze correction;
applying the haze correction that is based on the transmission map to the evaluation image;
applying the haze correction that is based on the transmission map to the image; and
correcting, based on an amount of change in the evaluation image before and after the application of the haze correction, brightness of the image to which the haze correction has already been applied.

14. A method executed by an apparatus, comprising:
applying haze correction to an image that includes a plurality of color components; and
correcting saturation of the image to which the haze correction has already been applied, by correcting a color difference of the image to which the haze correction has already been applied based on an amount of change in a color difference of the image before and after the application of the haze correction without changing a predetermined color component among the plurality of color components.

15. A non-transitory computer-readable storage medium which stores a program for causing a computer to execute a method comprising:
generating, based on an image, an evaluation image for haze correction;
generating, based on the evaluation image, a transmission map for the haze correction;
applying the haze correction that is based on the transmission map to the evaluation image;
applying the haze correction that is based on the transmission map to the image; and
correcting, based on an amount of change in the evaluation image before and after the application of the haze correction, brightness of the image to which the haze correction has already been applied.

16. A non-transitory computer-readable storage medium which stores a program for causing a computer to execute a method comprising:
applying haze correction to an image that includes a plurality of color components; and
correcting saturation of the image to which the haze correction has already been applied, by correcting a color difference of the image to which the haze correction has already been applied based on an amount of change in a color difference of the image before and after the application of the haze correction without changing a predetermined color component among the plurality of color components.
